(19) United States
(12) Patent Application Publication
(10) Pub. No.: US 2025/0196780 A1
(43) Pub. Date: Jun. 19, 2025

(54) LUGGAGE-CARRYING DEVICE CONFIGURED TO BE ATTACHED TO A REAR PART OF THE VEHICLE

(71) Applicant: SKEP, LA-TESTE-DE-BUCH (FR)

(72) Inventors: Théo LEALI, LA TESTE DE BUCH (FR); Pascal BENARD, BALMA (FR)

(21) Appl. No.: 18/840,998

(22) PCT Filed: Feb. 20, 2023
(86) PCT No.: PCT/FR2023/050239

§ 371 Date: Aug. 23, 2024

(30) Foreign Application Priority Data
Feb. 24, 2022 (FR) FR2201628

(51) Int. Cl. B60R 9/06

(52) U.S. Cl. CPC B60R 9/06

(57) ABSTRACT

The present disclosure relates to a luggage carrier device, including at least a first support member and at least a second support member, rotatably movable around a first axis between a closed position and an open position, wherein the device also includes at least a first locking device including: a locking surface provided with a locking opening; a locking member including a locking rod movable between a deployed position and a retracted position; when the device is in the closed position, a first end of the locking rod is inserted into the locking opening such that the second member is attached to the at least first member.

### CROSS REFERENCE TO RELATED APPLICATIONS

This application is a National S Stage of PCT Application No. PCT/FR2023/050239 filed on Feb. 20, 2023, which claims priority to French Patent Application No. FR 22/01628 filed on Feb. 24, 2022, the contents each of which are incorporated herein by reference thereto.

### TECHNICAL FIELD

The present disclosure relates to the field of luggage carrier devices for a vehicle and more particularly to a device configured to be fastened on a rear portion of the vehicle.

### BACKGROUND

Luggage carrier devices are devices that allow transporting at least one luggage item on an outer portion of the body of the vehicle. The luggage item may have any shape, any weight and any volume, such as a spare wheel, a solar shower, a bicycle, or a gasoline jerrican;

The terms “front”, “rear”, “top” and “bottom” of the vehicle are defined with reference to the vehicle in a forward travel situation. In other words, when a driver of said vehicle is normally seated in a driving position, said driver has the rear portion of the vehicle at his back, and faces the front of the vehicle.

The present disclosure relates to luggage carrier devices which are more specifically positioned on the outer portion of the body, at the rear of the vehicle.

A geometry of the outer portion of the body at the rear of the vehicle is variable depending on the vehicle, in particular a height, a width or a radius of curvature.

In general, the outer portion of the body at the rear of the vehicle is movable in one or more leaves, generally two, so as to be able to access an inner portion of the vehicle. The at least one leaf is movable according to an axis of rotation extending according to the width or the height of the vehicle.

There are luggage carrier devices for a vehicle which are configured to be fastened on a rear portion of the vehicle, and which comprise at least one first support member extending according to a first axis, and at least one second support member which is movable between a closure position in which the at least one second member extends substantially parallel to the at least one first member, and an opening position in which the at least one second member forms an angle with the at least one first member, the second member being held and locked in the closure position by means of a hook.

However, such a hook is bulky, requires the assembly of several parts and has a high manufacturing cost.

Furthermore, placing such a hook upon switch of the second member into the closure position requires handling by a user. Thus, the user might forget to position the hook, which results in a risk for the safety of the vehicle if the latter advances.

Moreover, the known luggage carrier devices poorly adapt to the different geometries of the outer portion of the body at the rear of the vehicle as well as to the presence of one or more leaf(es).

Finally, the known luggage carrier devices rarely enable transport of a heavy luggage load, that is to say heavier than 100 kg.

### BRIEF SUMMARY

The object of the present disclosure aims to remedy all or some of the aforementioned drawbacks by providing a luggage carrier device for a vehicle, said device being configured to be fastened on a rear portion of the vehicle, said device including at least one first support member intended to be fastened to the rear portion of the vehicle, and at least one second support member which is movable in rotation about a first axis between a closure position in which the at least one second member forms an angle with the at least one first member comprised within a first range of angle values, and an opening position in which the angle between the at least one second member and the at least one first member is comprised within a second range of angle values, characterized in that the device also comprises at least one first locking device including:
a locking surface provided with a locking opening, said locking surface being positioned on one amongst the at least one first member and the at least one second member;
a locking member including a locking rod which is movable according to a second axis between a deployed position and a retracted position, said locking member being positioned on the other one amongst the at least one first member and the at least one second member;
when the device is in the closure position, a first end of the locking rod is inserted into the locking opening so that the at least one second member is fastened to the at least one first member.

The luggage carrier device, and more particularly the second member, may be in the closure position. In this position, the second member forms an angle with the at least one first member comprised within a first range of angle values. For example, the first range of angle values is [0°; 20°], preferably [0°, 10°]. Preferably, the second member extends substantially parallel to the first member.

The second member may also be in the opening position. In this position, the second member can be brought away from the first member and form an angle with the first member comprised within a second range of angle values. For example, the second range of angle values is [0° and 360°], preferably [0°, 180°]. In the opening position of the device, it is possible to access the at least one leaf of the outer portion of the body at the rear of the vehicle.

The second member is secured to the first member, in the closure position, by means of the first locking device. Thus, there is no risk of an inadvertent change in the position of the second member, in particular when the vehicle is moving.

The first locking device includes, on the one hand, the locking surface and, on the other hand, the locking member, the locking surface being fastened on the at least one first member or on the at least one second member, whereas the locking member is fastened on the other one amongst the at least one first member and the at least one second member.

The locking surface includes a locking opening configured to cooperate with the first end of the locking rod. In other words, the first end of the locking rod can be inserted into the locking opening.

Thus, the device according to the present disclosure has a simple, economical and compact way for locking the second member on the first member.

The present disclosure may also have one or more of the following features considered separately or in combination.

According to one embodiment, the at least one first support member extends according to a third axis.

According to one embodiment, the first axis extends substantially perpendicular to the third axis.

According to one embodiment, the second axis extends substantially parallel to the first axis.

According to one embodiment, in the closure position, the second member extends according to the first member.

According to one embodiment, the second member is fastened at one end of the first member. According to one embodiment, the locking rod includes a second end provided with a handling element configured to be handled by a user.

According to one embodiment, the locking rod is movable in rotation or in translation according to the second axis.

According to one embodiment, a position of the locking rod according to an axis extending substantially perpendicular to the second axis and to the third axis is adjustable between a first adjustment position and a second adjustment position.

Thus, the locking device can be adapted between the first adjustment position and the second adjustment position.

According to one embodiment, the position of the locking rod according to the second axis is adjustable between a third adjustment position and a fourth adjustment position.

Thus, the position of the locking device can be adapted according to the second axis.

According to one embodiment, the locking rod of the locking member is in the deployed position at rest, and in the retracted position when a stress exerted substantially along the second axis is exerted on said locking rod.

Thus, the locking rod switches automatically from the retracted position into the deployed position if no stress is exerted on the locking member.

According to one embodiment, the locking surface also includes a guide surface configured to make the locking rod switch between the deployed position and the retracted position upon switch of the second member from the opening position into the closure position.

Thus, the guide surface allows retracting the locking rod until insertion thereof into the locking opening.

According to one embodiment, the guide surface is inclined with respect to a plane in which the locking opening extends.

Thus, the guide surface allows retracting the locking rod progressively.

The guide surface allows automatically positioning the locking rod in the locking opening when the second member switches from the opening position into the closure position. Hence, there is no longer any risk of a user forgetting to lock the second member on the first member.

According to one embodiment, the locking opening has an oblong shape which extends according to the third axis.

Thus, insertion of the locking rod into the locking opening is facilitated.

According to one embodiment, the device includes at least one support portion which includes at least one support surface configured to position the at least one second member in the same plane as the at least one first member when the device is in the closure position, said support surface being positioned on one amongst the at least one first member and the at least one second member.

Thus, when the second member is in the closure position, the support portion set the second member at the same level with the first member.

Furthermore, the support portion forms a load take-up support for the first member or the second member, which allows distributing a weight exerted by the luggage on the first member and the second member. Hence, the device according to the present disclosure allows for heavy loading.

According to one embodiment, the support surface also includes a support guide surface configured to make the at least one second member switch in the same plane as the at least one first member upon switch of the second member from the opening position into the closure position.

Thus, the switch of the at least one second member in the same plane as the at least one first member upon switch of the second member from the opening position into the closure position does not require any specific action by the user.

This switch is automatic upon closure of the second member.

According to one embodiment, the support guide surface is inclined with respect to the plane in which the at least first member extends.

Thus, the switch in the plane in which the first member extends is progressive.

According to one embodiment, the support guide surface is made of polymer, for example HDPE (high-density polyethylene) or Teflon.

Thus, the guide surface enables sliding of the first or second support member.

According to one embodiment, the support portion also includes a guide rod configured to cooperate with a guide opening of the support surface so as to guide a position of the second member upon switch from the opening position into the closure position.

The guide rod is positioned on the first or second member which does not support the support surface. Hence, the guide rod faces the support surface.

The guide rod is inserted into the guide opening upon switch of the second member from the opening position into the closure position. Hence, a position of the guide rod in the closure position is determined by a position of the guide opening.

According to one embodiment, the guide rod extends substantially parallel to the first axis.

According to one embodiment, the guide opening has an open “V”-like shape on a free edge of the support surface.

Thus, the guide rod is progressively guided in its final position when the second member is placed in the closure position.

According to one embodiment, a free end of the guide rod includes a retaining surface configured to be positioned in contact with the support surface so as to guide a position of the second member in the closure position according to an axis parallel to the axis of the guide rod.

Thus, the second member is retained in the plane of the first member when a stress is exerted on the second member according to an axis parallel to the axis of the guide rod. This situation could happen when the vehicle is travelling on a road with substantial deformations.

According to one embodiment, a position of the guide rod is adjustable according to an axis of elongation of the guide rod.

Thus, it is possible to adapt the position of the guide rod so that the retaining surface could be positioned perfectly with respect to the support surface.

According to one embodiment, the second support member includes a second locking device provided with at least one locking hook and/or at least one stop member, each of the at least one locking hook and the at least one stop member being configured to come into contact with the rear portion of the vehicle when the second member is in the closure position.

The second locking device is intended, on the one hand, to hold and, on the other hand, to retain the luggage carrier device when the vehicle is travelling forwards or braking. More specifically, the at least one hook limits a movement of the second member in a first direction, that is to say when a first force is exerted on the second member. The stop member limits a movement of the second member in a second direction, opposite to the first direction, that is to say when a second force, opposite to the first force, is exerted on the second member.

According to one embodiment, a position of the at least one locking hook according to a first adjustment axis is adjustable between a first adjustment position and a second adjustment position.

According to one embodiment, a position of the at least one locking hook according to a second adjustment axis is adjustable between a third adjustment position and a fourth adjustment position, the second adjustment axis forming an angle with the first adjustment axis comprised within a third range of angle values.

According to one embodiment, the third range of angle values is comprised between [45°, 180°], for example between [60°, 180°].

Thus, the position of the locking hook can be adapted to the rear portion of the vehicle.

According to one embodiment, a position of the at least one stop member is adjustable according to a first adaptation axis between a first adaptation position and a second adaptation position.

According to one embodiment, the position of the at least one stop member according to a second adaptation axis is adjustable between a third adaptation position and a fourth adaptation position, the second adaptation axis forming an angle with the first adaptation axis comprised within a fourth range of angle values.

According to one embodiment, the fourth range of angle values is [20°, 160°].

According to one embodiment, the position of the at least one stop member is movable in rotation about the first adaptation axis.

Thus, the position of the stop member can be adapted to the rear portion of the vehicle.

According to one embodiment, the second support member includes a fixed portion and a movable portion which is connected to the fixed portion by means of an axis of rotation, a position of the movable portion being adjustable by rotation between a first rotational position and a second rotational position.

According to one embodiment, the axis of rotation between the fixed portion and the movable portion extends substantially perpendicular to the first axis.

According to one embodiment, a position of the axis of rotation is adjustable according to an adjustment axis forming an adjustment angle with an axis of elongation of the fixed portion comprised within a range of adjustment angle values.

According to one embodiment, the range of adjustment angle values is comprised within the interval [0°, 90°].

Thus, the movable portion and the fixed portion of the second support member are movable relative to one another.

### BRIEF DESCRIPTION OF THE DRAWINGS

The present disclosure will be better understood, thanks to the description hereinafter, which relates to several embodiments according to the present disclosure, given as non-limiting examples and explained with reference to the appended schematic drawings, wherein:

FIG. 1 is a three-dimensional representation of a luggage carrier device according to the present disclosure wherein a second support member is in the closure position;

FIG. 2 is the three-dimensional representation of the luggage carrier device wherein the second support member is in the opening position;

FIG. 3 is an enlargement of FIG. 1;

FIG. 4 is a sectional view of a first locking device;

FIG. 5 is a three-dimensional view of a support portion according to the present disclosure;

FIG. 6 is a three-dimensional view of a second locking device according to the present disclosure positioned on a vehicle;

FIG. 7 is a sectional view of the second locking device;

FIG. 8 is a three-dimensional view of the second locking device according to the present disclosure;

FIG. 9 is a sectional view of a fixed portion and of a movable portion of the second support member.

### DETAILED DESCRIPTION

Only the elements necessary for understanding of the present disclosure have been represented. To facilitate reading of the drawings, the same elements bear the same references from one figure to another.

The present disclosure relates to a luggage carrier device 100 for a vehicle, said device 100 being configured to be fastened on a rear portion of the vehicle.

The terms “front”, “rear”, “top” and “bottom” of the vehicle are defined with reference to the vehicle in a forward travel situation. In other words, when a driver of said vehicle is normally seated in a driving position, said driver has the rear portion of the vehicle at his back, and faces the front of the vehicle.

The device 100 comprises at least one first support member 1 intended to be fastened on the rear portion of the vehicle, and more particularly on a chassis of the vehicle. The first support member 1 extends according to a third axis C. The first support member 1 has a substantially rectangular section and is in the form of a beam.

The first support member 1 is symmetrically extended at each end by a second support member 2. In the remainder of the description, reference will only be made to a second member 2 in order to simplify reading.

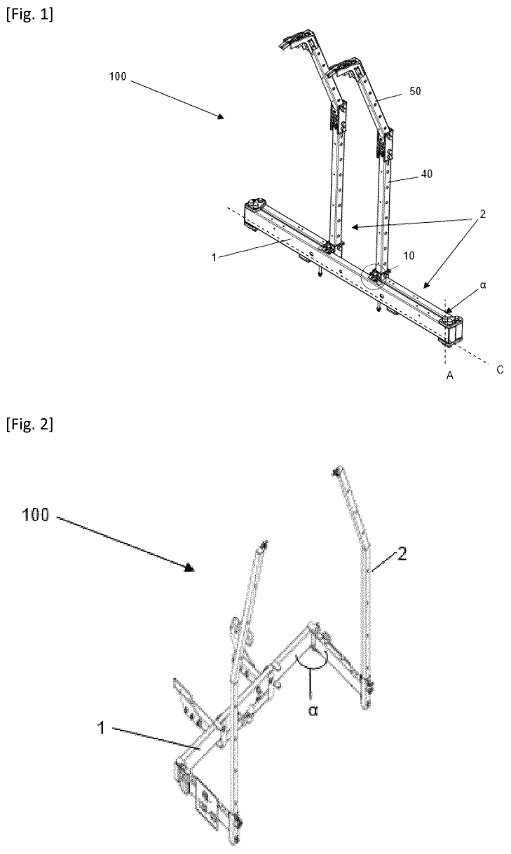

The second support member 2 is movable in rotation about a first axis A between a closure position illustrated in FIG. 1 and an opening position illustrated in FIG. 2. The first axis A extends substantially perpendicular to the third axis C. In the plane in which the first member 1 extends, the second member 2 has a substantially rectangular section and is in the form of a beam.

In the closure position, the second member 2 forms an angle α with the first member 1 comprised within a first range of angle values. For example, the first range of angle values is [0°; 20°], preferably [0°, 10°]. Preferably, the second member 2 extends substantially parallel to the first member 1. According to one embodiment, in the closure position, the portion of the second member 2 in the plane of the first member extends along the first member 1.

The second member 2 may also be in the opening position. In this position, the second member 2 can be brought away from the first member 1 so that the angle α formed with the first member 1 is comprised within a second range of angle values. For example, the second range of angle values is [0° and 360°], preferably [0°, 180°]. In the opening position of the device 100, it is possible to access the at least one leaf of the outer portion of the body at the rear of the vehicle 101.

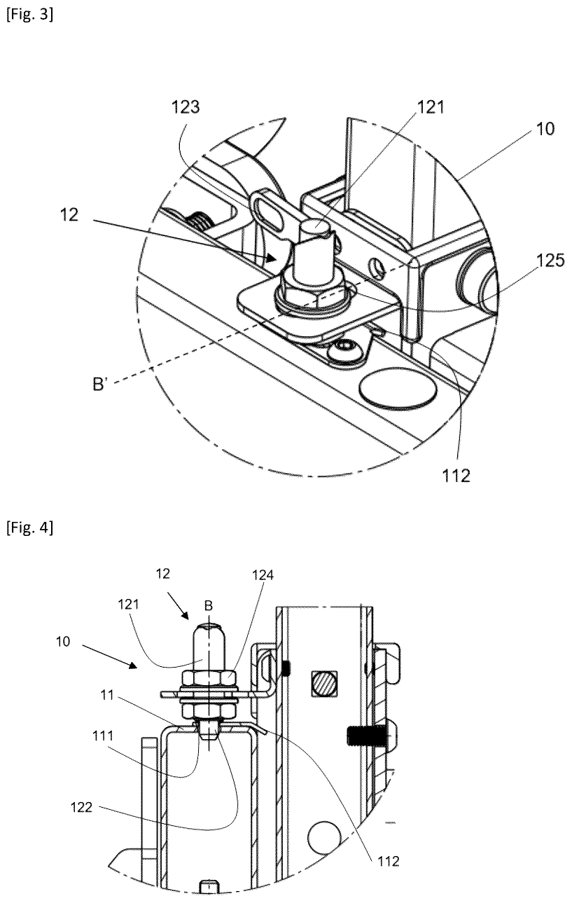

The second member 2 is secured to the first member 1, in the closure position, by means of a first locking device 0 represented in FIGS. 3 and 4.

The first locking device 10 comprises a locking surface 11 positioned on the first member 1. Similarly, the locking surface 11 could have been positioned on the second member 2. The locking surface 11 is provided with a locking opening 111 which extends on one face of the first member 1. The locking opening 111 has an oblong shape which extends according to the third axis C.

According to one embodiment, the locking surface 11 also comprises a guide surface 112 which is inclined with respect to a plane in which the locking opening 111 extends, that is to say in the plane in which the first member 1 extends.

The first locking device 10 comprises a locking member 12 positioned on the second member 2. The locking member 12 comprising a locking rod 121 which is movable in translation according to a second axis B between a deployed position and a retracted position.

The second axis B extends substantially parallel to the first axis A.

A position of the locking rod 121, with respect to the second member 2, is adjustable between a first adjustment position and a second adjustment position according to an axis B′ extending substantially perpendicular to the second axis B and at the third axis C. This adjustment is carried out through a displacement of the locking rod 121 in an oblong orifice 125 which extends according to the axis B′. The position of the locking rod 121 is fixed by tightening a nut system 124.

The position of the locking rod 121, with respect to the second member 2, is also adjustable between a third adjustment position and a fourth adjustment position according to the second axis B. This adjustment is carried out through a displacement of the locking rod 121 according to the second axis B by modification of a positioning according to the second axis B of the nut system 124.

The locking rod 121 comprises a second end provided with a handling element 123 configured to be handled by a user.

The locking rod 121 of the locking member 12 is in the deployed position at rest, and in the retracted position when a stress is exerted substantially according to the second axis B on said locking rod 121. Thus, the locking rod 121 automatically switches from the retracted position into the deployed position if no stress is exerted on the locking member 12.

The locking opening 11 is configured to cooperate with the first end 122 of the locking rod 121. In other words, the first end 122 of the locking rod 121 can be inserted into the locking opening 111.

In the opening position, without any particular handling by a user, no stress is exerted on the locking rod 121. Hence, the latter is in a deployed position.

Upon switch of the second member 2 from the opening position into the closure position, the second member 2 is brought close to the first member 1. The locking rod 121, and more particularly the first end 122 comes into contact with the guide surface 112 which exerts a stress according to the second axis B. Hence, the locking rod 121 progressively switches from the deployed position into the retracted position.

When the device 100 is in the closure position, the locking rod 121 is opposite the locking opening 111. No stress is no longer exerted on the locking rod 121 which returns back to the deployed position. Thus, the first end 122 of the locking rod 121 is inserted into the locking opening 111 so that the second member 2 is fastened to the first member 1.

Thus, the guide surface 112 allows progressively and automatically retracting the locking rod 121 until insertion thereof into the locking opening 111. Hence, there is no risk of the user forgetting to lock the second member 2 on the first member 1.

Thus, the device 100 according to the present disclosure has a simple, economical and compact way for locking the second member 2 on the first member 1.

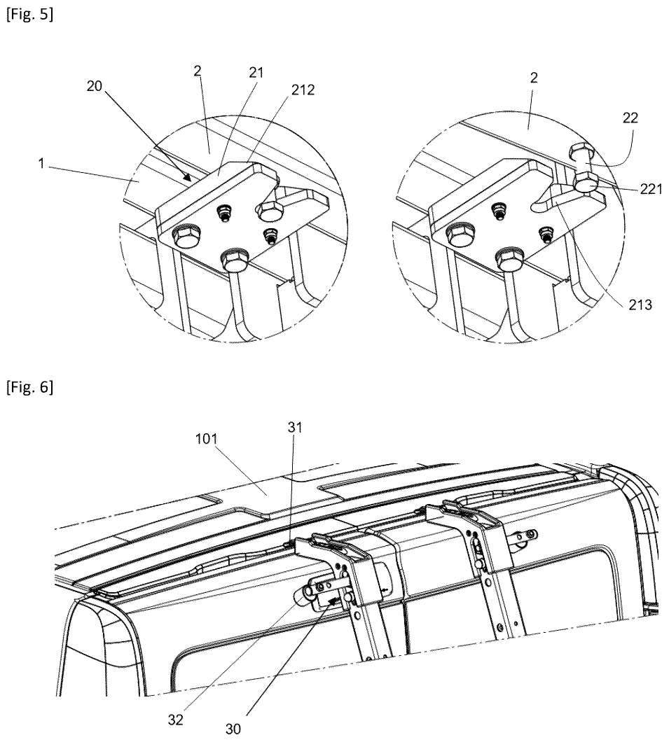

According to one embodiment, the device 100 comprises at least one support portion 20 which comprises a support surface 21 configured to position the second member 2 in the same plane as the first member 1 when the device 100 is in the closure position as illustrated in FIG. 5. The support portion 20 forms a load take-up support for the second member 2, which allows distributing a weight exerted by luggage on the first member 1 and on the second member 2. Hence, the device 100 according to the present disclosure allows for heavy loading.

The support surface 21 is positioned on the first member. Alternatively, it may be positioned on the second member 2. The support surface 21 is fastened on a face of the first member 1 opposite to a face comprising the locking surface 11.

The support surface 21 also comprises a support guide surface 212. The support guide surface 212 is inclined with respect to the plane in which the first member 1 extends. The support guide surface 212 is configured to switch progressively and automatically, that is to say without any specific action by the user, the second member 2 in the same plane as the first member 1 upon switch of the second member 2 from the opening position into the closure position.

According to one embodiment, the support guide surface 212 is made of polymer like for example HDPE (high-density polyethylene) or Teflon, thereby enabling sliding of the second support member 2.

According to one embodiment, the support surface 21 comprises a guide opening 213 which has an open “V”-like shape on a free edge of the support surface 21.

According to one embodiment, the support portion 20 also comprises a guide rod 22 positioned on the second member 2. Hence, the guide rod 22 faces the support surface 21. The guide rod 22 extends substantially parallel to the first axis A.

The guide rod 22 is progressively guided in its final position in the guide opening 213 upon switch of the second member 2 from the opening position into the closure position. Hence, a position of the guide rod 22 in the closure position is determined by a position of the guide opening 213.

According to one embodiment, a free end of the guide rod 22 comprises a retaining surface 221 configured to be positioned in contact with the support surface 21 so as to guide a position of the second member 2 in the closure position according to an axis parallel to the axis of the guide rod 22.

Thus, the second member 2 is retained in the plane of the first member 1 when a stress is exerted on the second member 2 according to an axis parallel to the axis of the guide rod 22. This situation could happen when the vehicle 101 is travelling on a road with substantial deformations.

According to one embodiment, a position of the guide rod 22 is adjustable according to an axis of elongation of the guide rod 22.

Thus, it is possible to adapt the position of the guide rod 22 so that the retaining surface 221 could be positioned perfectly with respect to the support surface.

According to one embodiment, the second support member 2 comprises a second locking device 30 provided with at least one locking hook 31 configured to come into contact with the rear portion of the vehicle 101 when the second member 2 is in the closure position. The locking hook 31 is movable between a locking position in which the locking hook 31 is in contact with the vehicle, as illustrated in FIG. 6, and a free position in which the locking hook 31 is not in contact with the vehicle. In the free position, provided that the first locking device 10 is in the retracted position, the second member 2 could be brought away from the first member 1 and thus access an internal portion of the vehicle.

The locking hook 31 is positioned at a free end of the second member 2.

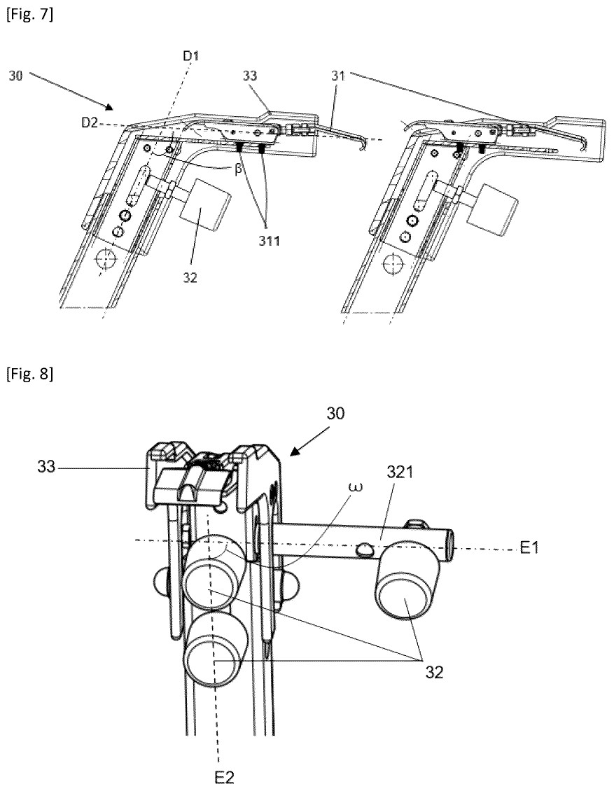

A position of the locking hook 31 according to a second adjustment axis D2 is adjustable between a third adjustment position and a fourth adjustment position as illustrated in FIG. 7. The second adjustment axis D2 extends substantially parallel to an axis of elongation of the vehicle, or to the axis B′. This adjustment is carried out by inserting at least one guide pin 311 of the locking hook into different openings.

A position of the locking hook 31 according to a first adjustment axis D1 is adjustable between a first adjustment position and a second adjustment position as illustrated in FIG. 7. The first adjustment axis D1 forms an angle β with the second adjustment axis D2 comprised within a third range of angle values. The third range of angle values is [60°, 120°].

Thus, the position of the locking hook 31 is adaptable to the rear portion of the vehicle.

The second locking device 30 is provided with at least one stop member 32 configured to come into contact with the rear portion of the vehicle 101 when the second member 2 is in the closure position.

The stop member 32 is positioned at a free end of the second member 2.

A position of the stop member 32 is adjustable according to a second adaptation axis E2 between a third adaptation position and a fourth adaptation position. This adjustment is carried out by inserting a pin of the stop member 32 into an opening.

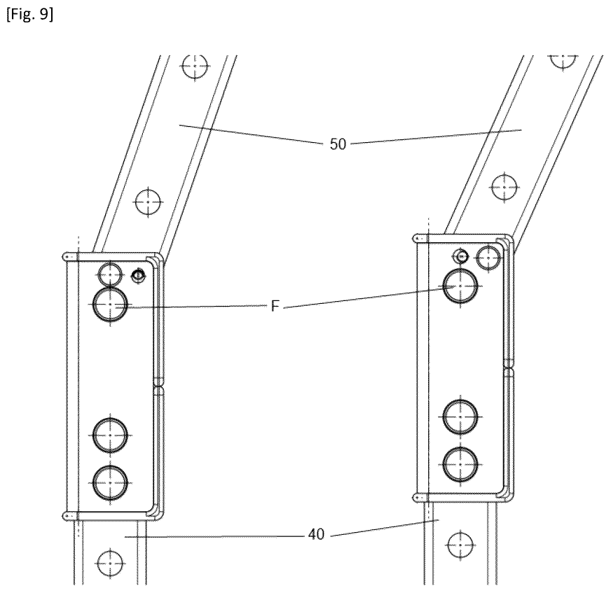

According to one embodiment, the position of the stop member 32 according to a first adaptation axis E1 is adjustable between a first adaptation position and a second adaptation position, the second adaptation axis E2 forming an angle GO with the first adaptation axis E1 comprised within a fourth range of angle values. The fourth range of angle values is [20°, 160°]. This adjustment is carried out by translation of a carrying bar 321 on which the stop member 32 is fastened according to the first adaptation axis E1, as illustrated in FIG. 8.

According to one embodiment, the position of the stop member 32 is movable in rotation according to the first adaptation axis E1.

Thus, the position of the stop member 32 is adaptable to the rear portion of the vehicle.

The second locking device 30 is intended, on the one hand, to hold and, on the other hand, to retain the luggage carrier device 100 when the vehicle 101 is travelling forwards or braking. More specifically, the at least one hook limits a movement of the second member 2 in a first direction, that is to say when a first force is exerted on the second member 2. The stop member 32 limits a movement of the second member 2 in a second direction, opposite to the first direction, that is to say when a second force, opposite to the first force, is exerted on the second member 2.

The second locking device 30 comprises a protective cover 33. The protective cover 33 covers the end of the second member 2 in order to make the projecting portions of the second locking device 30 inaccessible.

According to one embodiment, the second support member 2 has an “L”-like general shape, one end of which is connected to the first member 1 and a second end carries the second locking device 30. A portion of the second member 2 is in the plane of the first member 1, whereas the perpendicular portion extends in a normal plane of the plane of the first member 1.

The second member 2 comprises a fixed portion 40 and a movable portion 50 which is connected to the fixed portion 40 by means of an axis of rotation F, a position of the movable portion 50 being adjustable by rotation between a first rotational position and a second rotational position as illustrated in FIG. 9.

According to one embodiment, the axis of rotation F between the fixed portion 40 and the movable portion 50 extends substantially perpendicular to the first axis A and substantially parallel to the third axis C.

According to one embodiment, a position of the axis of rotation F is adjustable according to an adjustment axis forming an adjustment angle with an axis of elongation of the fixed portion 40 within a range of adjustment angle values.

According to one embodiment, the range of adjustment angle values is comprised within the interval [0°, 90°].

Thus, the movable portion 50 and the fixed portion 40 of the second support member 2 are movable relative to one another.

Of course, the present disclosure is not limited to the embodiments described and represented in the appended figures. Modifications are still possible, in particular with regards to the construction of the various members or by substitution with technical equivalents, yet without departing from the scope of the present disclosure.

1. A luggage carrier device for a vehicle, said device being configured to be fastened on a rear portion of the vehicle, said device comprising at least one first support member intended to be fastened to the rear portion of the vehicle, and at least one second support member which is movable in rotation about a first axis between a closure position in which the at least one second member forms an angle with the at least one first member comprised within a first range of angle values, and an opening position in which the angle between the at least one second member and the at least one first member is comprised within a second range of angle values, characterized in that the device also comprises at least one first locking device comprising:
a locking surface provided with a locking opening, said locking surface being positioned on one amongst the at least one first member and the at least one second member;
a locking member comprising a locking rod which is movable according to a second axis between a deployed position and a retracted position, said locking member being positioned on the other one amongst the at least one first member and the at least one second member;
when the device is in the closure position, a first end of the locking rod is inserted into the locking opening so that the at least one second member is fastened to the at least one first member, the second support member comprises a second locking device provided with at least one locking hook and/or at least one stop member, each of the at least one locking hook and the at least one stop member being configured to come into contact with the rear portion of the vehicle when the second member is in the closure position, a position of the at least one locking hook according to a first adjustment axis is adjustable between a first adjustment position and a second adjustment position.

2. The device according to claim 1, wherein the locking rod of the locking member is in the deployed position at rest, and in the retracted position when a stress exerted substantially along the second axis is exerted on said locking rod.

3. The device according to claim 1, wherein the locking surface also comprises a guide surface configured to make the locking rod switch between the deployed position and the retracted position upon switch of the second member from the opening position into the closure position.

4. The device according to claim 1, comprising at least one support portion which comprises at least one support surface configured to position the at least one second member in the same plane as the at least one first member when the device is in the closure position, the at least one support surface being positioned on one amongst the at least one first member and the at least one second member.

5. The device according to claim 4, wherein the at least one support surface also comprises a support guide surface configured to make the at least one second member switch in the same plane as the at least one first member upon switch of the second member from the opening position into the closure position.

6. The device according to claim 4, wherein the at least one support portion also comprises a guide rod configured to cooperate with a guide opening of the at least one support surface so as to guide a position of the second member upon switch from the opening position into the closure position.

7. The device according to claim 1, wherein a position of the at least one stop member is adjustable according to a first adaptation axis between a first adaptation position and a second adaptation position.

8. The device according to claim 1, wherein the second support member comprises a fixed portion and a movable portion which is connected to the fixed portion by means of an axis of rotation, a position of the movable portion being adjustable by rotation between a first rotational position and a second rotational position.

9. The device according to claim 2, wherein the locking surface also comprises a guide surface configured to make the locking rod switch between the deployed position and the retracted position upon switch of the second member from the opening position into the closure position.

10. The device according to claim 9, comprising at least one support portion which comprises at least one support surface configured to position the at least one second member in the same plane as the at least one first member when the device is in the closure position, the at least one support surface being positioned on one amongst the at least one first member and the at least one second member.

11. The device according to claim 10, wherein the at least one support surface also comprises a support guide surface configured to make the at least one second member switch in the same plane as the at least one first member upon switch of the second member from the opening position into the closure position.

12. The device according to claim 11, wherein the at least one support portion also comprises a guide rod configured to cooperate with a guide opening of the at least one support surface so as to guide a position of the second member upon switch from the opening position into the closure position.

13. The device according to claim 12, wherein a position of the at least one stop member is adjustable according to a first adaptation axis between a first adaptation position and a second adaptation position.

14. The device according to claim 13, wherein the second support member comprises a fixed portion and a movable portion which is connected to the fixed portion by means of an axis of rotation, a position of the movable portion being adjustable by rotation between a first rotational position and a second rotational position.

15. The device according to claim 2, comprising at least one support portion which comprises at least one support surface configured to position the at least one second member in the same plane as the at least one first member when the device is in the closure position, the at least one support surface being positioned on one amongst the at least one first member and the at least one second member.

16. The device according to claim 3, comprising at least one support portion which comprises at least one support surface configured to position the at least one second member in the same plane as the at least one first member when the device is in the closure position, the at least one support surface being positioned on one amongst the at least one first member and the at least one second member.

17. The device according to claim 15, wherein the at least one support surface also comprises a support guide surface configured to make the at least one second member switch in the same plane as the at least one first member upon switch of the second member from the opening position into the closure position.

18. The device according to claim 16, wherein the at least one support surface also comprises a support guide surface configured to make the at least one second member switch in the same plane as the at least one first member upon switch of the second member from the opening position into the closure position.

19. The device according to claim 17, wherein the at least one support portion also comprises a guide rod configured to cooperate with a guide opening of the at least one support surface so as to guide a position of the second member upon switch from the opening position into the closure position.

20. The device according to claim 18, wherein the at least one support portion also comprises a guide rod configured to cooperate with a guide opening of the at least one support surface so as to guide a position of the second member upon switch from the opening position into the closure position.
